(19) United States
(12) Patent Application Publication
(10) Pub. No.: US 2005/0251592 A1
(43) Pub. Date: Nov. 10, 2005

(54) Camera lighting source

(76) Inventors: Yi-Chang Chen, Yonghe City (TW); Tsan-Hsing Liu, Taipei City (TW)

Correspondence Address: BIRCH STEWART KOLASCH & BIRCH, PO BOX 747, FALLS CHURCH, VA, 22040-0747, US

(21) Appl. No.: 10/841,527

(22) Filed: May 10, 2004

(51) Int. Cl. G06F 13/10

(52) U.S. Cl. 710/62

(57) ABSTRACT

A camera lighting source comprising a body with an USB control circuitry, more than one USB ports and a movable camera are connected to the USB control circuitry, the USB control circuitry also connects to a power conversion circuitry, the power conversion circuitry connects to a lighting source; the USB control circuitry connects to a computer through an USB port to let the computer control the camera; with such scheme, the space needed is small since the camera is installed on the body, the angles and positions of the camera can be adjusted conveniently, the lighting source can offer the light needed easily; the computer also links to all the peripheral devices through the USB control circuitry.

### BACKGROUND OF THE INVENTION

I. Field of the Invention

This invention relates generally to a lighting source and, more specifically, to a camera lighting source that applies an USB control circuitry and USB ports to connects to a camera, the computer connects to all the peripheral devices through the USB control circuitry, the camera is installed on the stand of the lighting source, the camera is more convenient to apply.

II. Description of the Prior Art

Heretofore, it is known that the lighting equipments applying with computers are all connect to the computer through USB ports and apply computers' power except lamps. The lamps only offer lighting function.

Even though all the computers have limited USB ports, however the numbers of USB peripherals are getting more and more popular; USB converter products are therefore coming out.

Most of the computer cameras are installed either on table or fixed on computers.

Based on the description above, most of the USB peripherals have only one function; they are not only very complex in application but also in installation, the high cost and not user-friendly cause tedious and inconvenient condition. While cameras take pictures, lighting sources might be insufficient, external lightings are often needed, the external lightings need to be moved to get closer to the cameras, the application is not very convenient.

### SUMMARY OF THE INVENTION

It is therefore a primary object of the invention to provide a camera lighting source that comprises a body with a lighting source, the lighting source connects to a power conversion circuitry, the power conversion circuitry connects to power source and converts the input AC power into DC power; the power conversion circuitry also connects to an USB control circuitry, the USB control circuitry connects to a camera; the camera is installed close to the lighting source. While application, computer can control the camera through the USB control circuitry; with such scheme, the space needed is small since the camera is installed on the body, the angles and positions of the camera can be adjusted conveniently, the lighting source can offer the light needed easily.

It is still an object for the invention to provide a camera lighting source in which the USB control circuitry connects to more than one USB ports, the computer connects to the USB control circuitry through an USB port, the other peripheral devices link to the computer through the USB control circuitry; the USB ports are installed on the rim of the base with limited space, the numbers of USB ports can be increased.

It is still another object for the invention to provide a camera lighting source in which a switch is installed on the body, the switch connects to the power source and the power conversion circuitry; users can apply the switch to turn the system on and off.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is an electrical block diagram of the present invention;

FIG. 3 is an application view of the present invention.

### DESCRIPTION OF THE PREFERRED EMBODIMENT

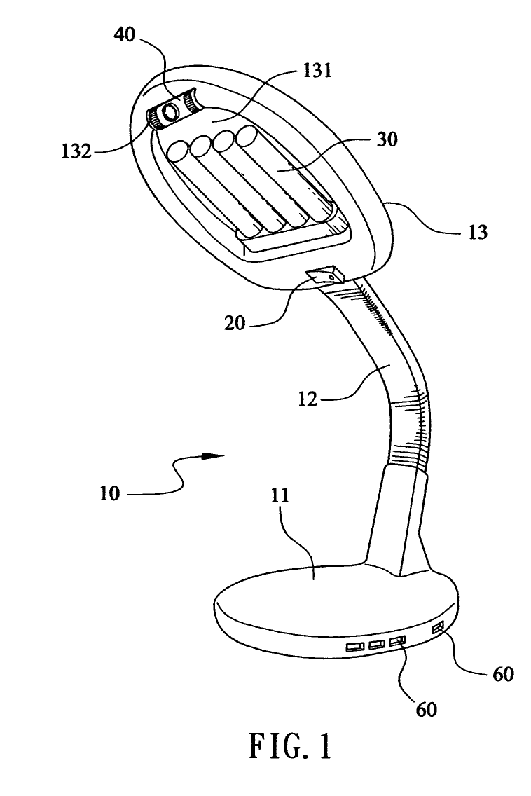

Referring to FIG. 1, the present invention comprises a body 10 with a base 11, a bendable supporter 12 are on the base 11, one end of the bendable supporter 12 connects to a stand 13, a switch 20 is on the stand 13, a indentation 131 with more than one lighting sources 30 is on the stand 13 (the light source in the present application is lamps), a turning axis 132 with a camera 40 is on the stand 13, while application, the turning axis 132 can adjust the position and angle of the camera 40.

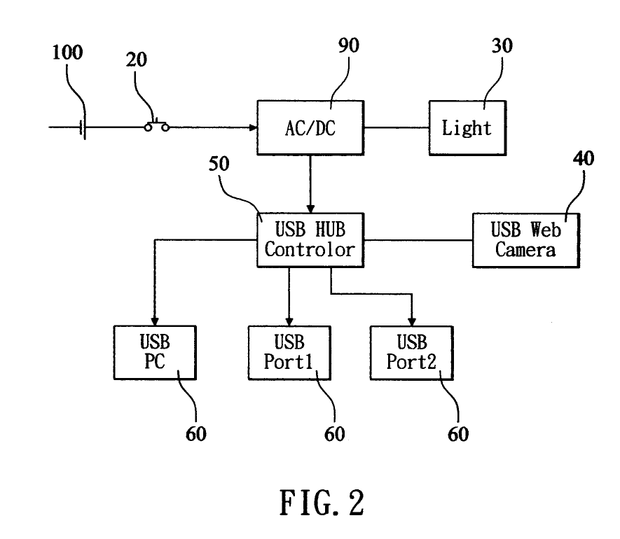

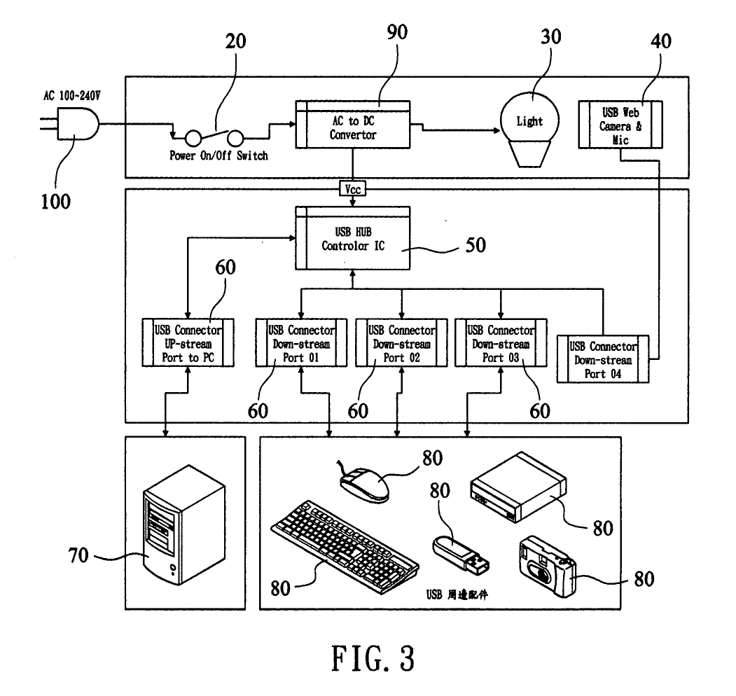

Referring to FIG. 2 and FIG. 3, an USB control circuitry 50 is inside the body 10, the USB control circuitry 50 connects to more than one USB ports 60 and a camera 40; the USB ports 60 are installed on the definite position on the body 10, they are on the rim of the base 11 in this application; the USB ports 60 links computer 70 and peripheral devices 80 (such as keyboard, mouse, CD ROM, Flash Disk and digital camera . . . ), as shown in FIG. 3.

The USB control circuitry 50 connects to a power conversion circuitry 90, the power conversion circuitry 90 converts AC power into DC power to offer power for the USB control circuitry 50, the power conversion circuitry 90 also connects to the lighting source 30 and the switch 20 of the stand 13 for users to turn on/off; the switch 20 connects to a power plug 100.

While application, referring to FIG. 1, FIG. 2 and FIG. 3, users turn on the switch 20 to have power enter the power conversion circuitry 90 and convert AC power into DC power, DC power offers power to the lighting source 30 and the USB control circuitry 50 to; the computer 70 connects to one of the USB ports 60 to connect to the USB control circuitry 50 and have the computer 70 control the camera 40 through the USB control circuitry 50; the camera 40 is installed on the stand 13 of the body 10 and can be adjusted with different positions and angles, the lighting source 30 offers the lighting needed; computer 70 can connect to peripheral devices 80 through USB ports 60 of the USB control circuitry 50.

While a preferred embodiment of the invention has been shown and described in detail, it will be readily understood and appreciated that numerous omissions, changes and additions may be made without departing from the spirit and scope of the invention.

1. A camera lighting source comprising:
a body;
a power conversion circuitry installed inside said body to convert AC power into DC power;
an USB control circuitry installed inside said body and connects to said power conversion circuitry;
a lighting source installed on the definite location of said body and connects to said power conversion circuitry for power needed;
a camera installed on said body near said lighting source and connects to said USB control circuitry;
more than one USB ports connect to said USB control circuitry, said USB control circuitry connects to a computer to let the computer control said camera through said USB control circuitry, the positions and angles of said camera can be adjusted easily, said lighting source offered light source needed, the computer can link to all the peripheral devices through said USB control circuitry.

2. The camera lighting source recited in claim 1, wherein a switch is installed on said body and connects to power source, said power conversion circuitry for users to turn on and off the system.

3. The camera lighting source recited in claim 1, wherein said lighting source is lamps.
